(19) United States
(12) Patent Application Publication
(10) Pub. No.: US 2008/0059674 A1
(43) Pub. Date: Mar. 6, 2008

(54) Apparatus and method for chained arbitration of a plurality of inputs

(76) Inventors: Jiaxiang Shi, Singapore (SG); Hong Lee Koo, Singapore (SG); Juraj Povazanec, Singapore (SG)

Correspondence Address: SLATER & MATSIL LLP, 17950 PRESTON ROAD, SUITE 1000, DALLAS, TX, 75252, US

(21) Appl. No.: 11/515,219

(22) Filed: Sep. 1, 2006

(51) Int. Cl. G06F 13/14

(52) U.S. Cl. 710/243

(57) ABSTRACT

An apparatus for chained arbitration of a plurality of inputs for access to a shared resource is provided. The apparatus includes a plurality of levels of arbiters including a first arbitration level having at least one first level arbiter, and a second arbitration level having at least one second level arbiter, the at least one first level arbiter comprising a locker module for generating a lock request signal to the at least one second level arbiter after locking one of the plurality of inputs, the at least one second level arbiter comprising a grant module for generating a grant signal to the at least one first level arbiter in response to the lock signal, whereby upon receipt of the lock signal the at least one first level grants access to the at least one second level arbiter for the locked one of the plurality of inputs.

### TECHNICAL FIELD

This invention relates to apparatus and method for chained arbitration of a plurality of inputs and preferably, though not exclusively, to such apparatus and method having a plurality of arbiters arranged in a plurality of levels of arbiters

### BACKGROUND

It is common for a microprocessor system to share a common memory resource by the microprocessor system, bus systems and a Direct Memory Access (“DMA”) controller with an arbiter being used to control access to the common memory resource. When peripheral controllers are connected to the same bus system and/or DMA controller, pre-bus arbitration or DMA arbitration must proceed before the memory arbitration. This chained arbitration creates problems of access latency and uncertainty of access.

It has been proposed to use a simple cascaded connection where the output port of the first arbiter is connected to an input port of the second arbiter, the output port of the second arbiter is connected to an input port of the third arbiter, and so forth. In such a system, the arbiters are arbitrating independently, the arbitration is not efficient, and there is uncertainty in the extent of delay in granting access to a specific requester. Also, redundant arbitration cycles may be introduced resulting in wasting system resources.

### SUMMARY OF THE INVENTION

In accordance with a first preferred aspect there is provided apparatus for chained arbitration of a plurality of inputs for access to a shared resource. The apparatus includes a plurality of levels of arbiters including a first arbitration level having at least one first level arbiter, and a second arbitration level having at least one second level arbiter. The at least one first level arbiter includes a locker module for generating a lock request signal to the at least one second level arbiter after locking one of the plurality of inputs. The at least one second level arbiter includes a grant module for generating a grant signal to the at least one first level arbiter in response to the lock signal. Upon receipt of the lock signal the at least one first level grants access to the at least one second level arbiter for the locked one of the plurality of inputs.

In accordance with a second preferred aspect there is provided apparatus for chained arbitration of a plurality of inputs for access to a shared resource. The apparatus includes a plurality of levels of arbiters including a first arbitration level having at least one first level arbiter, and a second arbitration level having at least one second level arbiter. The at least one second level arbiter includes a grant module for generating a grant signal to the at least one first level arbiter. The at least one first level arbiter is for arbitrating the plurality of inputs in response to the grant signal. The at least one first level arbiter includes a locker module for generating a lock signal to the at least one second level arbiter in consequence of the arbitration.

In accordance with a third preferred aspect there is provided a method for chained arbitration using a plurality of arbiters in a plurality of levels. The method comprises, in any order:

at least one first arbiter in a first level receiving a plurality of input requests for access to a shared resource;

the at least one first arbiter generating a lock request and sending it to at least one second arbiter in a second level;

the at least one second arbiter generating a grant signal and sending it to the at least one first arbiter; and

the at least one arbiter granting access to the at least one second arbiter for one of the plurality of input requests.

For the third aspect the lock request may be generated and sent by the at least one first arbiter after receiving the grant signal. Before generating the lock request and sending it to the at least one second arbiter, the at least one first arbiter may perform an arbitration of the plurality of input requests. The one of the plurality of input requests may be locked before the lock request is generated and sent.

For all aspects there may be a plurality of first level arbiters, the number of first level arbiters being determined by the number of inputs. There may be a plurality of second level arbiters, the number of second level arbiters being determined by the number of first level arbiters and a number of further inputs to the plurality of second level arbiters. There may be at least one third level arbiter in a third arbitration level.

### DESCRIPTION OF THE DRAWINGS

In order that the invention may be fully understood and readily put into practical effect there shall now be described by way of non-limitative example only a preferred embodiment of the present invention, the description being with reference to the accompanying illustrative drawings. In the drawings:

FIG. 1 is an illustration of a simple cascaded connection according to the prior art;

FIG. 2 is an illustration of a preferred embodiment; and

FIG. 3 is an illustration of the arbitration according to the preferred embodiment.

### DETAILED DESCRIPTION OF ILLUSTRATIVE EMBODIMENTS

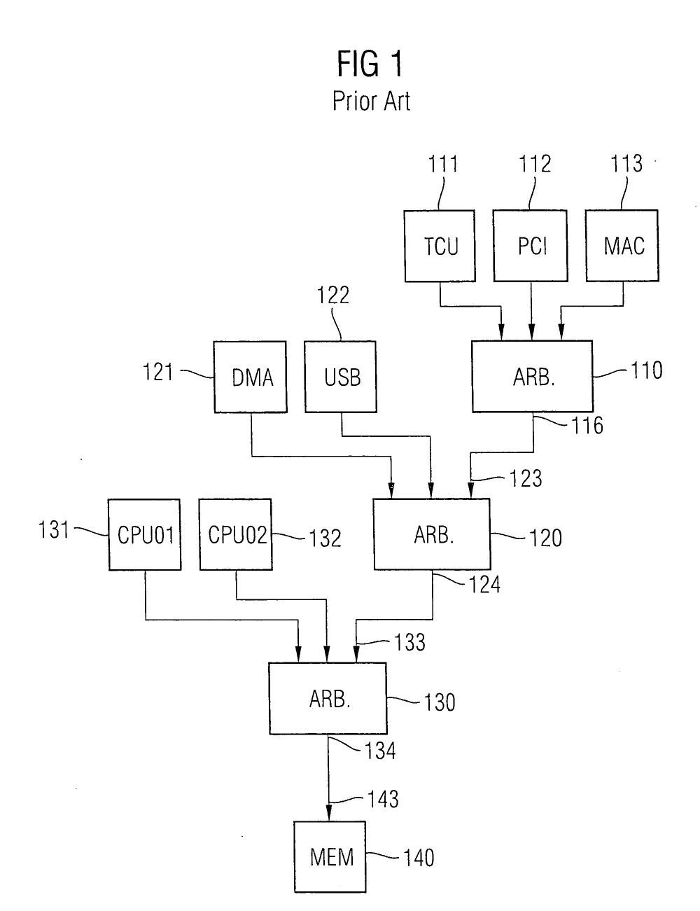

To first refer to FIG. 1, there is shown a system according to the prior art. It has a first arbiter and data multiplexer 110 in a first level. The arbiter 110 has a plurality of inputs including a timing control unit 111, a peripheral component interconnect 112 and a media-specific access controller 113. Output 116 from arbiter 110 is an input 123 into a second arbiter and multiplexer 120. Second arbiter 120 is in a second level and has further inputs from a direct memory access controller 121 and a USB controller 122. The output 124 from second arbiter 120 is an input 133 into a third arbiter and multiplexer 130 in a third level. Also input to the third arbiter 130 is a first CPU 131 and a second CPU 132. The output 134 from third arbiter 130 is input 143 to a memory 140.

Each arbiter 110, 120 and 130 runs independently of the other arbiters. The inputs (requestors) to each arbiter in a lower level—arbiters 120 and 130—must wait for a relatively long random time to have access to memory 140. Only the last level arbiter 130 does not waste arbitration cycles due to the next level resource availability being unknown during the present arbitration cycle.

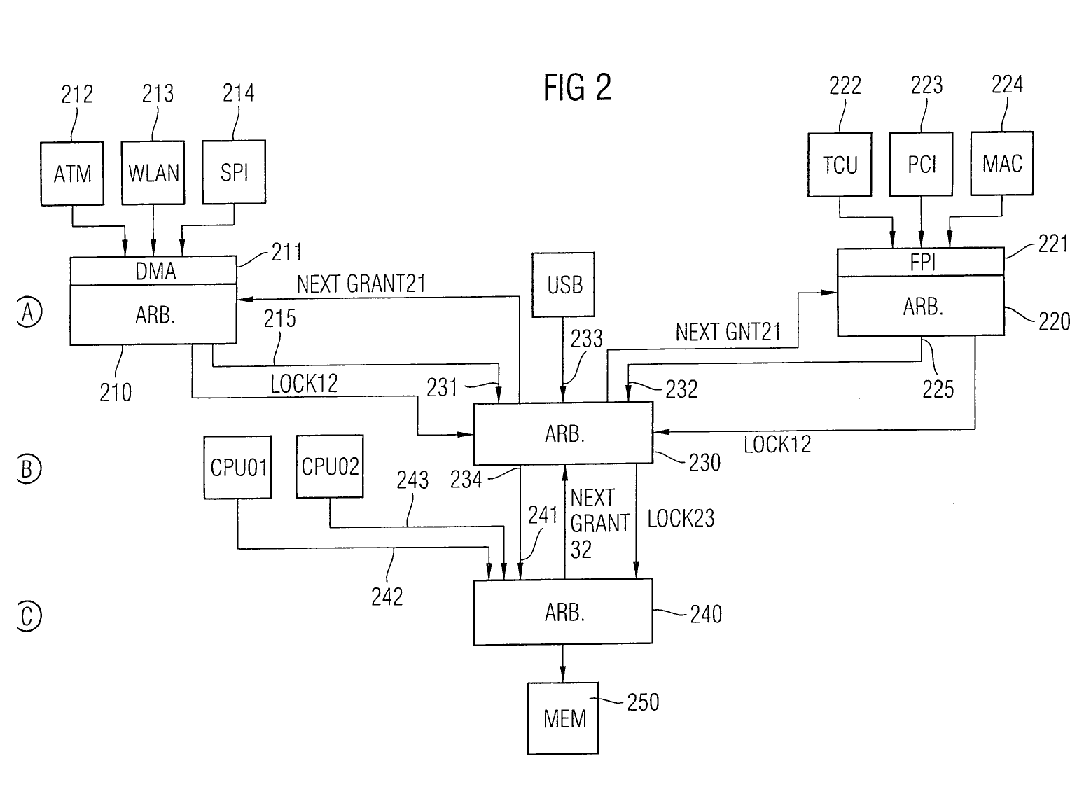

FIG. 2 shows the structure according to a preferred embodiment. Here there are four arbiters arranged in three levels. The arbiters include: a first arbiter 210 in a first level A and a second arbiter 220 also in the first level A, a third arbiter 230 in a second level B, and a fourth arbiter 240 in a third level C. The first level A may contain any required or desired number of arbiters from one to a required or desired number. The number of arbiters in the first level A will, generally, be determined by the number of inputs as if an arbiter has an excessive number of inputs it tends to operate more slowly. Similarly, the number of arbiters in the second level B will be determined by the number of arbiters in the first level A, and any extra inputs to the arbiters in the second level B. The number of arbiters should be selected to optimize the operating speed of the arbiters. This will apply to all levels of arbiters. In a similar fashion, the number of levels of arbiters will be determined.

Furthermore, the issue of priority will impact the number of arbiters in each level, and the number of levels of arbiters. In the structure of FIG. 2, the highest priority inputs will be to the arbiter 240 in level C. It is, therefore, preferable to have a number of levels of arbiters corresponding to or greater than the number of orders of priority of inputs (requesters). However, the number of levels is independent of the number of inputs at each level, and the number of inputs at each level is independent of the number of levels. Therefore, they are independent of each other. There must be at least two levels.

The first arbiter and data multiplexer 210 has a direct memory access controller 211 and three inputs: an asynchronous transfer mode controller 212, a wireless local area network 213, and a service provider interface 214. The arbiter 210 has an output 215 that is an input 231 to the third arbiter 230.

The second arbiter and data multiplexer 220 has a formal public identifier 221 with three inputs: a timing control unit 222, peripheral component interconnect 223 and media-specific access controller 224. The arbiter 220 has an output 225 that is an input 232 to the third arbiter 230.

The third arbiter and data multiplexer 230 has the two inputs 231, 232 described above as well as an input from a USB controller 233. The input 233 is of an order of priority that is one level higher than the inputs to the first level A, but may be the same order of priority or a higher order of priority as the inputs 231, 232. The arbiter 230 has an output 234 that is an input 241 for fourth arbiter 240 in level C.

Fourth arbiter and data multiplexer 240 has two other inputs: a first input 242 from a first CPU and a second input 243 from a second CPU. The inputs 242 and 243 are of an order of priority that is one level higher than the inputs to the second level B, but may be the same order of priority or a higher order of priority as the input 241. The arbiter 240 has an output 244 that is the input to the memory 250.

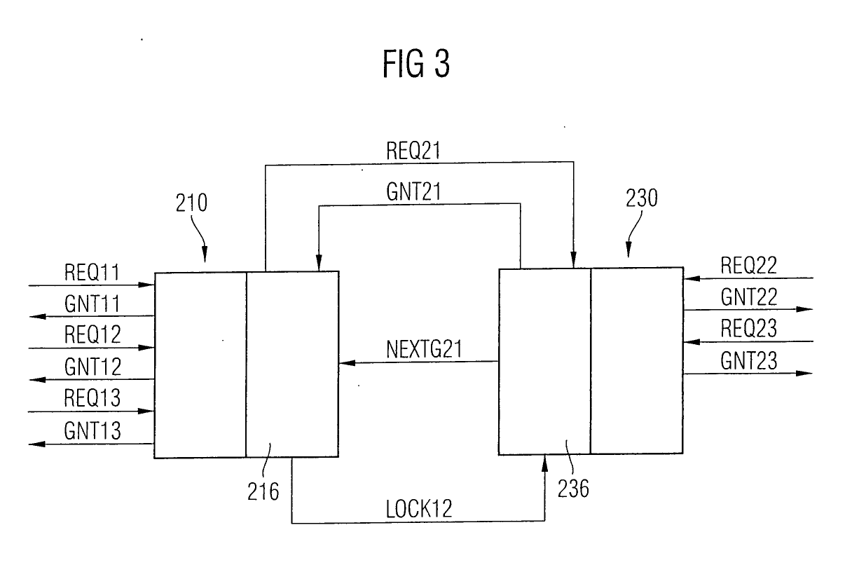

Reference to FIG. 3 provides an example of the operation of the lock-ahead method of operating the preferred embodiment. First arbiter 210 has three inputs each of which is a request for access to the memory 250: REQ11, REQ12 and REQ13. The arbiter 210 considers the three inputs and takes the first-received request such that there is no arbitration, or the request of highest priority (e.g., request REQ11) such that there is arbitration, “locks” it using a locker module 216 by not releasing the grant to any requester, and relays the request REQ11 to the third arbiter 230 as a lock request REQ21. Arbiter 210 waits on the grant GNT21 of the request from arbiter 230. When the grant module 236 of the third arbiter 230 generates the grant GNT21 it arrives at arbiter 210. Arbiter 210 relays the grant GNT21 to the “locked” request REQ11 as GNT11 thereby allowing input REQ11 access to arbiter 230. Therefore, each arbiter in each level will lock one input request until the grant is received from the next level arbiter.

FIGS. 2 and 3 also provide an example of the operation of the look-ahead/lock-next method of operation. In this mode of operation, the grant module 236 of the arbiter 230 sends a grant signal NextG21 to the first arbiter 210. The arbiter 210 monitors the signal NextG21 and, if it is true, arbitrates its inputs REQ11, REQ12 and REQ13. In the next arbitration cycle arbiter 210 determines which of the inputs REQ11, REQ12 and REQ13 is granted access for the arbiter 210 and, therefore, is granted access to the third arbiter 230. Optionally, the first arbiter 210 can send a lock signal Lock12 to the third arbiter to lock the third arbiter 230 to prevent other resource competitors from gaining access. This will be advantageous if one of the requests REQ11, REQ12 and REQ13 has a higher level of priority. This provides priority access through to the input stage of the fourth arbiter 240. If the fourth and third arbiter, 240 and 230 respectively, have performed the same “look-ahead/lock-next” procedure, the priority access can be through to memory 250.

As such, for both operational modes, the next level resource is available by no later than the next arbitration cycle. With lock ahead it can be with zero arbitration cycle delay. Arbitration cycles are, therefore, not wasted. Also, high priority requests can achieve a definite access path through the various stages of arbitration. The shared resource (memory 250) has improved utilization by reducing access arbitration cycles.

Whilst there has been described in the foregoing description a preferred embodiment of the present invention, it will be understood by those skilled in the technology concerned that many variations in details of design, construction and operation may be made without departing from the present invention.

What is claimed is:

1. An apparatus for chained arbitration of a plurality of inputs for access to a shared resource, the apparatus comprising:
a plurality of levels of arbiters comprising a first arbitration level having at least one first level arbiter, and a second arbitration level having at least one second level arbiter;
the at least one first level arbiter comprising a locker module for generating a lock request signal to the at least one second level arbiter after locking one of the plurality of inputs; and
the at least one second level arbiter comprising a grant module for generating a grant signal to the at least one first level arbiter in response to the lock request signal;
whereby upon receipt of the lock request signal, the at least one first arbiter level grants access to the at least one second level arbiter for the locked one of the plurality of inputs.

2. The apparatus as claimed in claim 1, wherein an output of the at least one first level arbiter is input to the at least one second level arbiter.

3. The apparatus as claimed in claim 1, wherein the at least one first level arbiter comprises a plurality of first level arbiters, the number of first level arbiters being determined by the number of inputs.

4. The apparatus as claimed in claim 3, wherein the number of second level arbiters is determined by the number of first level arbiters and a number of further inputs to the at least one second level arbiter.

5. The apparatus as claimed in claim 4, wherein the further inputs are of an order of priority higher than that of the plurality of inputs.

6. The apparatus as claimed in claim 5, further comprising at least one third level arbiter in a third arbitration level, wherein the at least one third level arbiter receives a number of additional inputs of a higher order of priority than the further inputs.

7. The apparatus as claimed in claim 1, further comprising at least one third level arbiter in a third arbitration level for receiving an output from the at least one second level arbiter.

8. The apparatus as claimed in claim 1, wherein the number of levels in the plurality of levels is at least as great as a number of orders of priority of the plurality of inputs.

9. The apparatus as claimed in claim 1, wherein the number of the plurality of levels and the number of inputs at each level are independent of each other.

10. An apparatus for chained arbitration of a plurality of inputs for access to a shared resource, the apparatus comprising:
a plurality of levels of arbiters comprising a first arbitration level having at least one first level arbiter, and a second arbitration level having at least one second level arbiter;
the at least one second level arbiter comprising a grant module for generating a grant signal to the at least one first level arbiter;
the at least one first level arbiter arbitrating the plurality of inputs in response to the grant signal; and
the at least one first level arbiter comprising a locker module for generating a lock signal to the at least one second level arbiter in consequence of the arbitration.

11. A method for chained arbitration using a plurality of arbiters in a plurality of levels, the method comprising:
at least one first arbiter in a first level receiving a plurality of input requests for access to a shared resource;
the at least one first arbiter generating a lock request and sending it to at least one second arbiter in a second level;
the at least one second arbiter generating a grant signal and sending it to the at least one first arbiter; and
the at least one first arbiter granting access to the at least one second arbiter for one of the plurality of input requests.

12. The method as claimed in claim 11, wherein the lock request is generated and sent by the at least one first arbiter after receiving the grant signal.

13. The method as claimed in claim 12, wherein before generating the lock request and sending it to the at least one second arbiter, the at least one first arbiter performs an arbitration of the plurality of input requests.

14. The method as claimed in claim 11, wherein one of the plurality of input requests is locked before the lock request is generated and sent.

15. The method as claimed in claim 11, wherein there are a plurality of first arbiters in the first level, the number of first arbiters in the first level is determined by the number of inputs.

16. The method as claimed in claim 11, wherein there are a plurality of second arbiters in the second level, the number of second arbiters in the second level is determined by the number of first arbiters in the first level and a number of further inputs to the plurality of second arbiters.

17. The method as claimed in claim 11, further comprising at least one third arbiter in a third level.
